(19) United States
(12) Patent Application Publication
(10) Pub. No.: US 2017/0282406 A1
(43) Pub. Date: Oct. 5, 2017

(54) Method for Controlling a Wall Saw System During the Creation of a Separation Cut

(71) Applicant: Hilti Aktiengesellschaft, Schaan (LI)

(72) Inventors: Wilfried Kaneider, Rankweil (AT); Dragan Stevic, Feldkirch-Tosters (AT); Christian Bereuter, Lingenau (AT)

(73) Assignee: Hilti Aktiengesellschaft, Schaan (LI)

(21) Appl. No.: 15/509,442

(22) PCT Filed: Sep. 3, 2015
(86) PCT No.: PCT/EP2015/070101

§ 371 Date: Mar. 7, 2017

(30) Foreign Application Priority Data
Sep. 8, 2014 (EP) 14003101.4

(51) Int. Cl. B28D 7/00; B28D 1/04

(52) U.S. Cl. CPC B28D 7/005; B28D 1/044; B28D 1/045

(57) ABSTRACT

A method for controlling a wall saw system during creation of a separation cut in a workpiece between a first and second end point, where at least one of the end points is defined as an obstacle, is disclosed. The separation cut is carried out in a plurality of main cuts. In addition to a main-cut sequence, a corner-cut sequence having at least two corner cuts is defined for each end point defined as an obstacle. For each corner-cut sequence, a starting position and an end position are defined, the corner cuts being carried out therebetween. The wall saw is positioned in the starting position and is pivoted into a first corner-cut angle. Subsequently, the saw head is moved by way of the inclined saw arm until the end position has been reached. The wall saw is displaced back into the starting position and pivoted into a second corner-cut angle.

This application claims the priority of International Application No. PCT/EP2015/070101, filed Sep. 3, 2015, and European Patent Document No. 14003101.4, filed Sep. 8, 2014, the disclosures of which are expressly incorporated by reference herein.

### BACKGROUND AND SUMMARY OF THE INVENTION

The present invention relates to a method for controlling a wall saw system during the creation of a separation cut.

A method is known from EP 1 693 173 B1 for controlling a wall saw system during the creation of a separation cut in a workpiece between a first end point and a second end point. The wall saw system comprises a guide rail and a wall saw with a saw head, a motor-driven feed unit that moves the saw head parallel to a feed direction along the guide rail, and at least one saw blade attached to a saw arm of the saw head and driven by a drive motor about an axis of rotation. The saw arm is pivotable by means of a pivoting motor about a pivot axis. By a pivoting movement of the saw arm about the pivot axis, the penetration depth is changed in the workpiece. The motor-driven feed unit comprises a guide carriage and a feed motor, wherein the saw head is mounted on the guide carriage and moved via the feeding motor along the guide rail. To monitor the wall saw system, a sensor device is provided with a pivot angle sensor and a displacement sensor. The pivot angle sensor measures the present pivot angle of the saw arm and the displacement sensor measures the actual position of the saw head on the guide rail. The measured values for the current pivot angle of the saw arm and the actual position of the saw head are regularly sent to a control unit of the wall saw.

The known method for controlling a wall saw system is divided into a preparation part and processing of the separation cut. In the preparation part, the operator sets at least the saw blade diameter of the saw blade, the positions of the first and second end points in the feed direction, and the final depth of the separation cut; other parameters can be the material of the workplace to be machined and the dimensions of embedded rebar. From the parameters entered, the control unit determines an appropriate main cutting sequence of main cuts for the separation cut, wherein the main cutting sequence comprises at least a first main cut having a first main cutting angle of the saw arm and a first diameter of the saw blade used, and a following second main cut with a second main cutting angle of the saw arm and a first diameter of the saw blade used.

The known method for controlling a wall saw system has the disadvantage that no details are disclosed on the corner processing of an end point defined as barrier.

The object of this invention is to develop a method for controlling a wall saw system in which the corner processing of a barrier is controlled by the wall saw's control unit.

In the method for controlling a wall saw system named in the introduction, according to the invention this object is solved by the features of the independent claim. Advantageous developments are indicated in the dependent claims.

The invention provides that before the start of the processing controlled by the control unit, in addition to the main cutting sequence for the at least one end point defined as barrier, a corner cutting sequence with corner cuts is determined, wherein the corner cutting sequence comprises at least a first corner cut with a first corner cutting angle of the saw arm and the first diameter of the saw blade used, as well as a second corner cut with a second corner cutting angle of the saw arm and a second diameter of the saw blade used. The processing parameters of the wall saw can be adapted to the corner processing by defining a separate corner cutting sequence for the corner processing.

The corner cutting sequence preferably comprises a number of n corner cuts, n≧2 with j^{th} corner cutting angles (±φ_{1,j}, ±φ_{2,j}) of the saw arm (17) and the j^{th} diameter (D_{1,j}, D_{2,j}) of the saw blade used, j=1 to n. The number of corner cuts necessary, among other things, depends on the specification of the saw blade, the material properties of the workpiece, and the power and torque of the drive motor for the saw blade. The corner cutting angle can be determined by the operator, or the control unit of the wall saw system can establish the corner cutting angle depending on various boundary conditions. For the inventive method, the corner cutting angles are an input amount used for controlling the wall saw.

Before the start of the processing controlled by the control unit, also preferred is a length of the saw arm, defined as the distance between the pivot axis of the saw arm and the axis of rotation of the saw blade, and that determines the distance between the pivot axis and an upper side of the workpiece. For a controlled processing of the separation cut, the control unit must know various parameters. These include the saw arm length, which is a fixed device-specific size of the wall saw, and the vertical distance between the pivot axis and the surface of the workpiece, which, besides the geometry of the wall saw, also depends on the geometry of the guide rail used.

In a first embodiment, the first end point is defined as a barrier and, for the corner cutting sequence, a first end position is calculated by the control unit wherein the pivot axis in the first end position has a position coordinate of X(E₁)+Dₘ/2−δ sin(±αₘ) for |±αₘ|≦α_{crit} and X(E₁)+Dₘ/2−δ sin(±α_{crit}) for α_{crit}<|±αₘ|. When the pivot axis has reached the first end position, the remaining material, is removed as much as possible and the separation cut in the area of the first end point is completed.

In a further development of the first embodiment, in the j^{th} corner cut of the corner cutting sequence, j=1 to n the saw head is positioned in a first initial position, the saw arm is pivoted at the j^{th} corner cutting angle, and the saw head is moved with the saw arm inclined at the j^{th} corner cutting angle into the first end position.

Particularly preferably, in the first initial position the pivot axis has a position coordinate of X(E₁)+D_{1,n}/2−δ sin(±φ_{1,n}) for |±φ_{1,n}|≦α_{crit} and X(E₁)+D_{1,n}/2−δ sin(±α_{crit}) for αφ_{1,n}|. The first initial position assures that the pivoting movement at all overcut angles of the overcut sequence occurs before the first end point and the first end point is not exceeded.

In a preferred embodiment, the penultimate main cut is done with a blade guard and before the start of the controlled processing additionally a mounting distance Δₘₒᵤₙₜ and a penultimate width for the blade guard used in the penultimate main cut is determined, whereas the penultimate width is composed of a first distance of the axis of rotation to the first blade guard edge and a second distance of the axis of rotation to the second blade guard edge.

Particularly preferably, the controlled processing is interrupted by the control unit and the wall saw is moved by the control unit into a first park position.

The pivot axis in the first park position has a position coordinate of X(E₁)+maximum value of [B_{1,m-1}+Δₘₒᵤₙₜ, B_{1,m-1}−δ sin(±αₘ)] for |±αₘ|≦90° or X(E₁)+maximum value of [B_{1<m-1}+Δₘₒᵤₙₜ, B_{1,m-1}−δ sin(±α_{crit})] for 90°<|±αₘ|.

After resumption of the controlled processing, the wall saw is positioned in a first resumption position that corresponds to the first park position. If the control unit in addition to the park position defines a resumption position, after the interruption the wall saw can be moved by the operator from the park position by means of the motor-driven drive unit along the guide rail. The possibility of being able to move the wall saw from the park position is advantageous for vertical or diagonal separation cuts in a wall in which the park position is arranged above a manageable mounting position. After the resumption, the control unit with the aid of the displacement sensor checks the current position of the wall saw. If the current position deviates from the resumption position, the wall saw is positioned in the resumption position.

In a second embodiment, the second end point is defined as barrier and for the corner cutting sequence a second end position is calculated by the control unit wherein the pivot axis in the second end position has a position coordinate of X(E₂)−Dₘ/2−δ sin(±αₘ) for |±αₘ|≦α_{crit} and X(E₂)−Dₘ/2−δ sin(±α_{crit}) for α_{crit}<|±αₘ|. When the pivot axis has reached the second end position, the remaining material is removed as much as possible and the separation cut in the area of the second end point is completed,

In a further development of the second embodiment, in the j^{th} corner cut of the corner cutting sequence, j=1 to n the saw head is positioned in a second initial position, the saw arm is pivoted at the j^{th} corner cutting angle, and the saw head is moved with the saw arm inclined at the j^{th} corner cutting angle into the second end position.

Particularly preferably, in the second initial position the pivot axis has a position coordinate of X(E₂)−Dₙ/2−δ sin(±φ_{2,n}) for |±φ_{2,n}|≦α_{crit} and X(E₂)−D_{2,n}/2−δ sin(±α_{crit}) for α_{crit}<|±φ_{2,n}|. The second initial position assures that the pivoting movement at all overcut angles of the overcut sequence occurs before the second end point and the second end point is not exceeded.

In a preferred embodiment, the final main cut is done with a blade guard and before the start of the controlled processing. Additionally a mounting distance Δₘₒᵤₙₜ and a final width for the blade guard used in the final main cut Is determined, whereas the last width is composed of a first distance of the axis of rotation to the first blade guard edge and a second distance of the axis of rotation to the second blade guard edge.

Particularly preferably, the controlled processing is interrupted by the control unit and the wall saw is moved by the control unit into a second park position. The pivot axis in the second park position has a position coordinate of X(E₂)−maximum value of [B_{2,m}+Δₘₒᵤₙₜ, B_{2,m}−δ sin(±αₘ)] for |±αₘ|≦90° or X(E₂)−maximum value of [B_{2,m}+ΔₘₒᵤₙₜB_{2,m}+δ sin(±90°)] for 90°<|±αₘ|.

Embodiments of the invention are described below based on the drawings. These do not necessarily represent the embodiments to scale; instead, where helpful for the explanation, the drawings are produced in schematic and/or slightly distorted form. Regarding additions to the teachings directly evident from the drawings, reference is made to the relevant prior art. It must be kept in mind that various modifications and changes to the form and detail of an embodiment can he made without deviating from the general idea of the invention. The invention's features disclosed in the description, drawings, and claims can be essential both individually and in any combination for the development of the invention. In addition, all combinations of at least two of the features described in the description, drawings, and/or claims fall within the framework of the invention. The general idea of the invention is not restricted to the exact shape or detail of the embodiments shown and described below or restricted to a subject matter that would be restricted compared to the subject matter claimed in the claims. Where dimension areas are given values lying inside the given boundaries are also disclosed as limit values and can be used and claimed randomly. For the sake of simplicity, the same reference signs are used below for identical or similar parts or parts with identical or similar function.

### BRIEF DESCRIPTION OF THE DRAWINGS

FIG. 1 illustrates a wall saw system with a guide rail and a wall saw;

FIGS. 2A, B illustrate processing of a separation cut between a first and second free end point without barrier;

FIGS. 3A, B illustrate processing of a separation cut between a first and second barrier with a saw blade that is not surrounded by a blade guard;

FIGS. 4A, B illustrate processing of a separation cut between a first and second barrier with a saw blade that is surrounded by a blade guard; and

FIGS. 5A-N illustrate the wall saw system of FIG. 1 in creating a separation cut between a first barrier and a second free end and a second barrier.

### DETAILED DESCRIPTION OF THE DRAWINGS

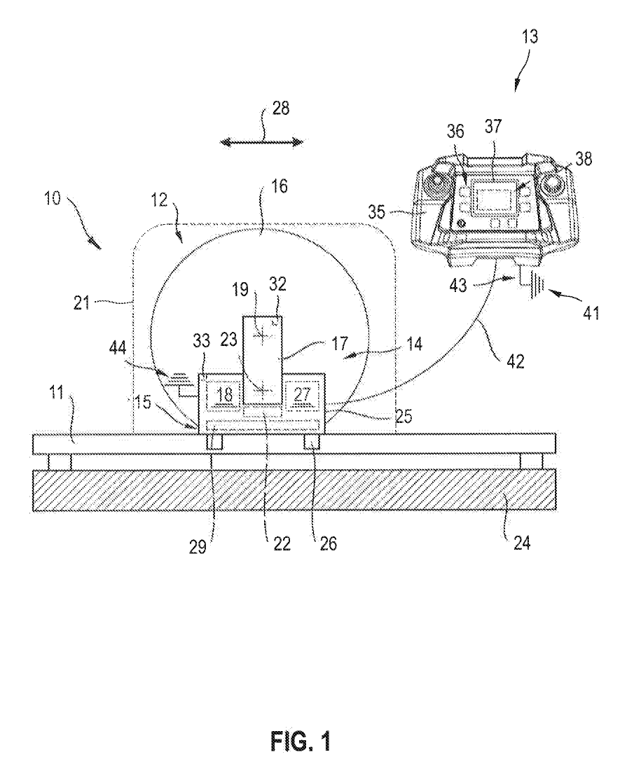

FIG. 1 shows a wall saw system 10 with a guide rail 11, a tool device 12 arranged displaceably on the guide rail 11, and a remote control 13. The power tool is configured as a wall saw 12 and comprises a processing unit 14 and a motor-driven feed unit 15. The processing unit is configured as a saw head 14 and includes a machining tool 16 designed as a saw blade, which is attached to a saw arm 17 and is driven by a drive motor 18 about an axis of rotation 19.

To protect the operator, the saw blade 18 is surrounded by a blade guard 21, which is secured by means of a blade guard holder on the saw arm 17. The saw arm 17 is formed from a pivoting motor 22 to pivot about a pivot axis 23. The pivot angle a of the saw arm 17 determines with a blade diameter D of the saw blade 16, how deep the blade 16 dips into a workpiece 24 to be processed. The drive motor 18 and the pivoting motor 22 are arranged in a device housing 25. The motor-driven feed unit 15 comprises a guide carriage 26 and a feed motor 27 that in the embodiment is also arranged in the device housing 25. The saw head 14 is fixed on the guide carriage 26 and designed to be displaceable through the feed motor 27 along the guide rail 11 in a feed direction 28. In the device housing 25 in addition to the motors 19, 22, 27 a control unit 29 is arranged for controlling the saw head 14 and the motor-driven feed unit 15.

To monitor the wall saw system 10 and the processing procedure, a sensor device is provided with several sensor elements. A first sensor element 32 is designed as a pivot angle sensor and a second sensor element 33 as a displacement sensor. The pivot angle sensor 32 measures the current pivot angle of the saw arm 17 and the displacement sensor 33 measures the current position of the saw head 14 on the guide rail 11. The measured values are transmitted by the pivot angle sensor 32 and displacement sensor 33 to the control unit 29 and used for controlling the wall saw 12.

The remote control 13 comprises a device housing 35, an input device 36, a display device 37, and a control unit 38 that is arranged in the interior of the device housing 35. The control unit 38 converts the inputs of the input device 36 into control commands and data that are transmitted via a first communication link to the wall saw 12. The first communication link is configured as a wireless and cordless communication link 41 or a communications cable 42. The wireless and cordless communication link is formed in the embodiment as a radio link 41 created between a first radio unit 43 on the remote control 13 and a second radio unit 44 on the tool device 12. Alternatively, the wireless and cordless communication link 41 can be in the form of an infrared, Bluetooth, WLAN, or Wi-Fi connection.

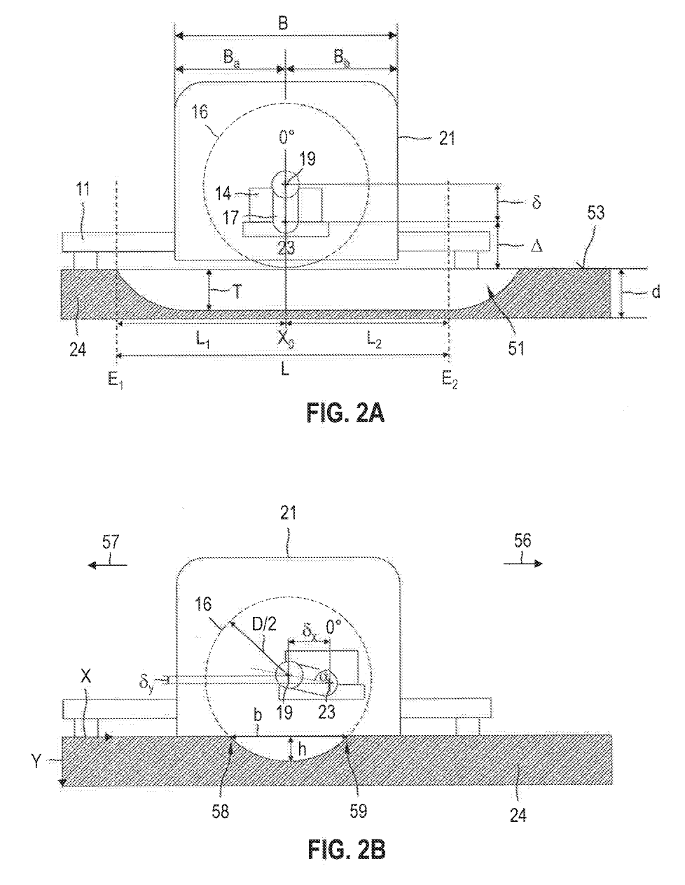

FIGS. 2A, B show the guide rail 11 and the wall saw 12 of the wall saw system 10 of FIG. 1 at the creation of a separation cut 51 in the workpiece 24 of workpiece thickness d. The separation cut 51 has a final depth T and extends in the feed direction 28 between a first end point E₁ and a second end point E₂. A direction parallel to the feed direction 28 is defined as the X direction, wherein the positive X direction is from the first end point E₁ to the second end point E₂, and a direction perpendicular to the X direction into the workpiece 24 is defined as the Y direction.

The end point of a separation cut can be defined as free end point without barrier or as barrier. Both end points can be defined as free end points without barrier, both end points as barrier, or one end point as free end point and the other end point as barrier. An overcut can be allowed at a free end point without barrier. Through the overcut, at the end point, the depth of cut reaches the final depth T of the separation cut. In the embodiment of FIGS. 2A, B the end points E₁, E₂ form free end points without barrier, wherein on the free first end point E₁ an overcut is not permissible and on the second end point E₂ there is an overcut.

FIG. 2A shows the saw head 14 in a mounting position X₀ and the saw arm 17 in a basic position of 0°. The saw head 14 is positioned by the operator by means of the guide carriage 26 in the mounting position X₀ on the guide rail 11. The mounting position X₀ of the saw head 14 lies between the first and second end points E₁, E₂ and is determined, by the position of the pivot axis 23 in feed direction 28. The position of the pivot axis 23 is particularly suited as reference position X_{Ref} for the position monitoring of the saw head 14 and control of the wall saw 12, since the X position of the pivot axis 23 also remains unchanged during the pivoting movement of saw arm 17. Alternatively, another X position on the saw head 14 can be established as reference position, wherein in this case the distance in the X direction to the pivot axis 23 must additionally be known.

The X positions of the first and second end points E₁, E₂ are determined in the embodiment by the entry of partial lengths. The distance between the mounting position X₀ and the first end point E₁ determines a first partial length L₁ and the distance between the mounting position X₀ and the second end point E₂ a second partial length L₂. Alternatively, the X positions of the end points E₁, E₂ can be established by entering a partial length (L₁or L₂) and a total length L as the distance between the end points E₁, E₂.

The separation cut 51 is produced in multiple partial cuts until the desired final depth T is reached. The partial cuts between the first and the second end points E₁, E₂ are defined as the main cut and the cutting sequence of the main cut as the main cutting sequence. At the end points of the separation cut an additional corner processing can be performed, which, in cases with a barrier, is called barrier processing and, in cases with a free end point with overcut, is called overcut processing.

The main cutting sequence can be either determined by the operator or determined by the control unit of the wall saw system, depending on several boundary conditions. Usually the first main cut, also called precut, is made with a reduced depth of cut and a reduced power of the drive motor to prevent a polishing of the saw blade. The remaining main cuts are normally done with the same depth of cut, but can also have different cut depths. The boundary conditions usually established by an operator include the cut depth of the precut, the power of the precut, and the maximum depth of cut of the remaining main cuts. The control unit can determine the main cutting sequence from these boundary conditions.

The main cuts of a separation cut are done with one saw blade diameter or with two or more saw blade diameters. If multiple saw blades are used, the processing usually starts with the smallest saw blade diameter. To be able to mount the saw blade 16 on the saw arm 17, in the basic position of saw arm 17 the saw blade 16 must be arranged above the workpiece 24. Whether this boundary condition is fulfilled depends on two device-specific sizes of the wall saw system 10: a perpendicular distance Δ between the pivot axis 23 of saw arm 17 and an upper side 53 of the workpiece 24, and the saw arm length δ of saw arm 17, defined as the distance between the axis of rotation 19 of saw blade 16 and the pivot axis 23 of saw arm 17. If the total of these two device-specific amounts is greater than half the saw blade diameter D/2, the saw blade 16 in the basic position is arranged above the workpiece 24. The saw arm length δ is a fixed, device-specific amount of wall saw 12, whereas the perpendicular distance Δ between the pivot axis 23 and the surface 53, besides the geometry of wall saw 12, also depends on the geometry of the guide rail 11 used.

The saw blade 16 is fastened on a flange on saw arm 17 and, in the saw operation, is driven by drive motor 18 around the axis of rotation 19. In the basic position of saw arm 17, shown in FIG. 2A, the pivot angle is 0° and the axis of rotation 19 of the saw blade 16 lies in depth direction 52 above pivot axis 23. The saw blade 16 is moved by a pivoting movement of saw arm 17 around the pivot axis 23 from the basic position at 0° into the workpiece 24. During the pivoting movement of saw arm 17, saw blade 16 is driven by drive motor 18 around the axis of rotation 19.

To protect the operator, during operation the saw blade 16 should be surrounded by blade guard 21. Wall saw 12 is operated either with blade guard 21 or without blade guard 21. For processing of the separation cut in the area of end points E₁, E₂, a dismounting of blade guard 21 can be provided. If different saw blade diameters are used for processing the separation cut, different blade guards with corresponding blade guard width are also used.

FIG. 2B shows saw arm 17 which, in the negative rotational direction 54, is inclined at negative pivot angle −α. In the negative rotational direction 54 the saw arm 17 is adjustable between pivot angles from 0° to −180°, and in a positive rotational direction 55, counter to the negative rotational direction 54, is adjustable between pivot angles from 0° to +180°. The arrangement of saw arm 17 shown in FIG. 2B is identified as pulling if saw head 14 is moved in a positive feed direction 56. If saw head 14 is moved in a negative feed direction 57 counter to the positive feed direction 56, the arrangement of saw arm 17 is called pushing.

The maximum penetration depth of saw blade 16 into workpiece 24 is reached at a pivot angle of ±180°. The position of the axis of rotation 19 in the X direction and Y direction is shifted by the pivoting movement of saw arm 17 around pivot axis 23. The displacement of pivot axis 19 depends on the saw arm length δ and pivot axis α of saw arm 17. The displacement δₓ in the X direction is δ sin(±α) and the displacement δ_{y} in the Y direction is δ cos(±a).

The saw blade 16 produces in workpiece 24 a cutting edge in the shape of a circular segment with a height h and width b. The height h of the circular segment corresponds to the penetration depth of saw blade 16 into workpiece 24. The relationship D/2=h+Δ+δ cos (α) applies for the penetration depth h, where D designates the saw blade diameter, h the penetration depth of saw blade 16, Δ the perpendicular distance between pivot axis 23 and upper side 53 of workpiece 24, δ the saw arm length, and a the first pivot angle, and for the width b the relationship b²=D/2 8h−4h²=4Dh−4h²=4h (D−h) applies, where h designates the penetration depth of saw blade 16 into workpiece 24 and D the saw blade diameter.

The control of wall saw 12 during the separation cut depends on whether the end points are defined as barriers and, if there is a barrier, whether the processing is done with blade guard 21 or without blade guard 21. With a free end point without barrier, the control of wall saw 12 in the inventive method occurs through upper exit points of saw blade 18 at upper side 53 of workpiece 24. The upper exit points of saw blade 16 can be calculated from the reference position X_{Ref} of pivot axis 23 in the X direction, displacement δₓ of axis of rotation 19 in the X direction, and width b. An upper exit point facing the first end point E₁ is designated as first upper exit point 58, and an upper exit point facing the second end point E₂ as second upper exit point 59. For the first upper exit point 58, X(58)=X_{REF}+δₓ−b/2 applies and, for the second upper exit point 59, X(59)=X_{REF}+δₓ+b/2 with b=√[h(D−h)] and h=h(α, D) applies.

If the end points E₁, E₂ are defined as barriers, an overrun of the end points E₁, E₂ with wall saw 12 is not possible. In this case, the control of wall saw 12 in the inventive method occurs through the reference position X_{Ref} of pivot axis 23 and the limit of wall saw 12. A distinction is made between a processing without blade guard 21 and a processing with blade guard 21.

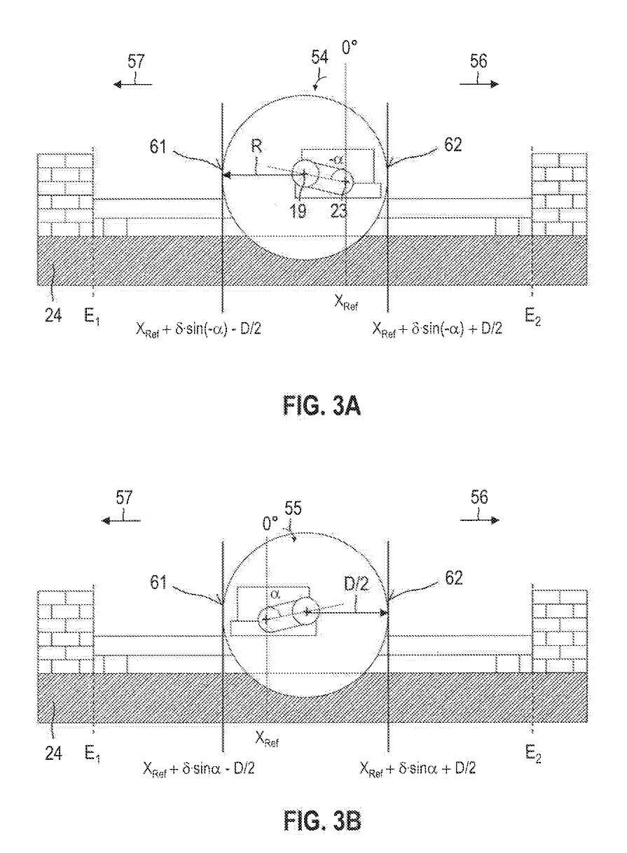

FIGS. 3A, B show the wall saw system 10 when producing a separation cut between the first end point E₁ and the second end point E₂, which are defined as barriers, wherein the processing occurs without blade guard 21. In the processing without blade guard 21, a first saw blade edge 61, facing the first end point E₁, and a second saw blade edge 62, facing the second end point E₂, form the limit of the wall saw 12.

The X positions of the first and second saw blade edges 61, 62 in the X direction can be calculated from the reference position X_{Ref} of pivot axis 23, displacement δₓ of axis of rotation 19 and saw blade diameter D. FIG. 3A shows the wall saw 12 with the saw arm 17 inclined in the negative rotational direction 54 at a negative pivot angle −α (0° to −180°). For the first saw blade edge 61, X(61)=X_{Ref}+δ sin(−α)−D/2 applies and, for the second saw blade edge 62, X(62)=X_{Ref}+δ sin(−α)+D/2 applies. FIG 3B shows wall saw 12 with saw arm 17 inclined in a positive rotational direction 55 at a positive pivot angle α (0° to +180°). For the first saw blade edge 61, X(61)=X_{Ref}+δ sin(α)−D/2 applies and, for the second saw blade edge 62, X(62)=X_{Ref}+δ sin(α)+D/2 applies.

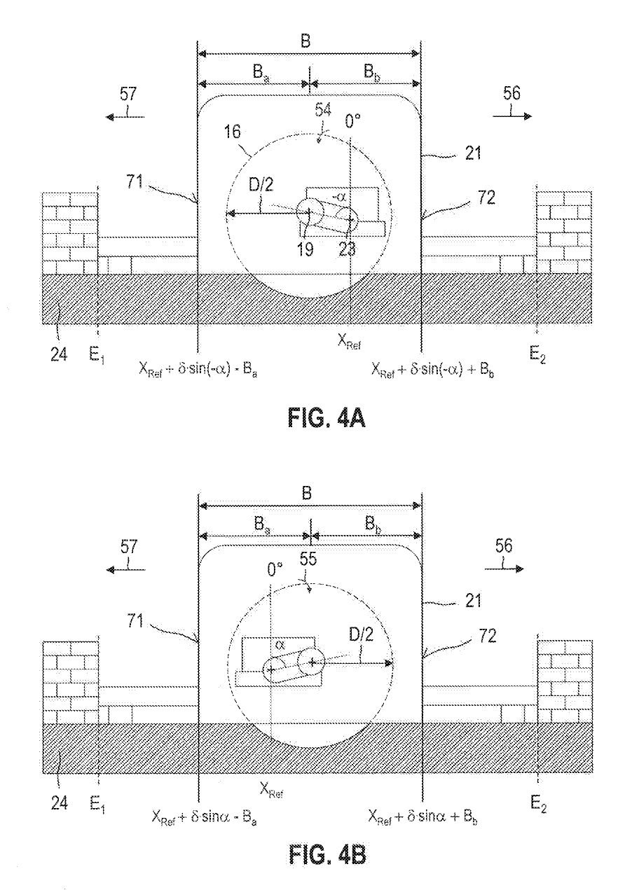

FIGS. 4A, B show the wall saw system 10 when creating a separation cut between the first end point E₁ and the second end point E₂, defined as barriers, wherein the processing is done with blade guard 21. In the processing without blade guard 21, a first blade guard edge 71 facing the first end point E₁ and a second blade guard edge 72 facing the second end point E₂ form the limit of wall saw 12.

The X positions of the first and second blade guard edges 71, 72 in the X direction can be calculated from the reference position X_{Ref} of pivot axis 23, displacement δₓ of axis of rotation 19, and blade guard width B. FIG. 4A shows the wall saw 12 with saw arm 17 inclined at a negative pivot angle −α (0° to −180°and a mounted blade guard 21 of blade guard width B. In an asymmetrical blade guard, before the start of the controlled processing, the distances of the axis of rotation 19 to the blade guards 71, 72 are determined, wherein the distance to the first blade guard edge 71 is identified as first distance Bₐ and the distance to the second blade guard edge 72 as second distance B_{b}.

For the first blade guard edge 71, X(71)=X_{Ref}+δ sin(α)·Bₐ applies and, for the second blade guard edge 72, X(72)=X_{Ref}+δ sin(α)+B_{b} applies. FIG. 4B shows the wall saw 12 with the saw arm 17 inclined at positive swivel angle α (0° to +180°), and the mounted blade guard 21 of the blade guard width B. For the first blade guard edge 71, X(71)=X_{Ref}+δ sin(α)−Bₐ applies and for the second blade guard edge 72, X(72)=X_{ref}+δ sin(α)+B_{b} applies.

FIGS. 2A, B show a separation cut between two end points E₁, E₂, which are defined as free end. points without barrier, and FIGS. 3A, B and 4A, B show a separation cut between two end points E₁, E₂, which are defined as barriers. In practice, separation cuts are also possible in which one end point is defined, as a barrier and the other end is a free end without barrier, wherein the control of the wall saw with the free end point occurs through the upper exit point of the saw blade and with the barrier through the blade edge (processing without blade guard 21) or the blade guard edge (processing with blade guard 21).

The first upper exit point 58, the first blade edge 61, and the first blade guard edge 71 are summarized under the term “first limit” of wall saw 12 and the second upper exit point 59, the second blade edge 62. and the second blade guard edge 72 are summarized under the term “second limit.”

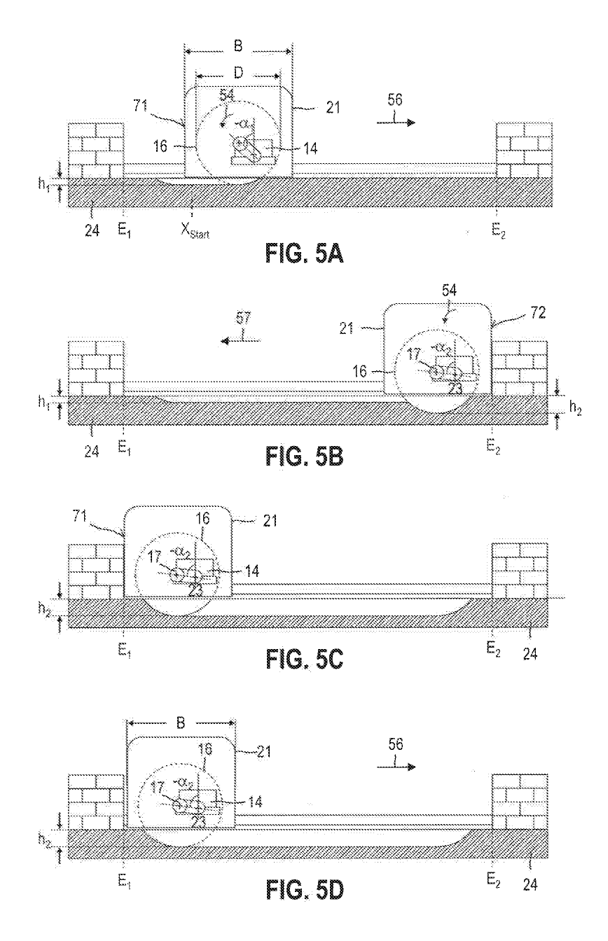

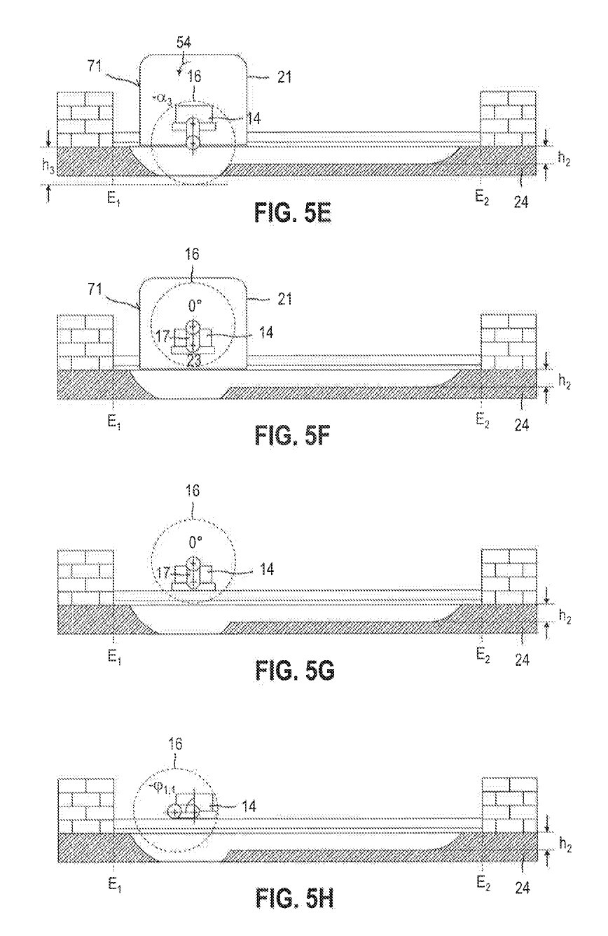

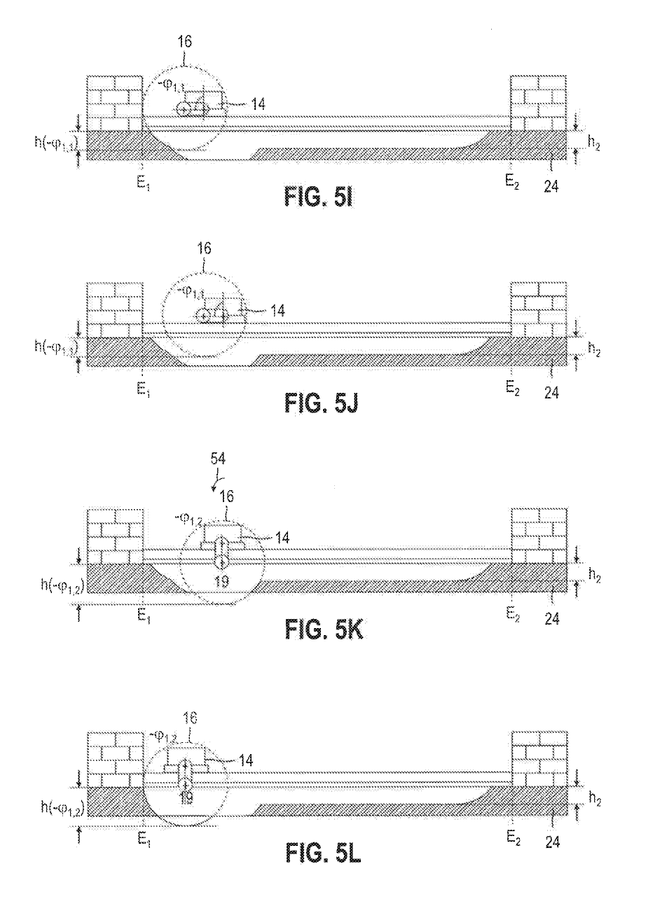

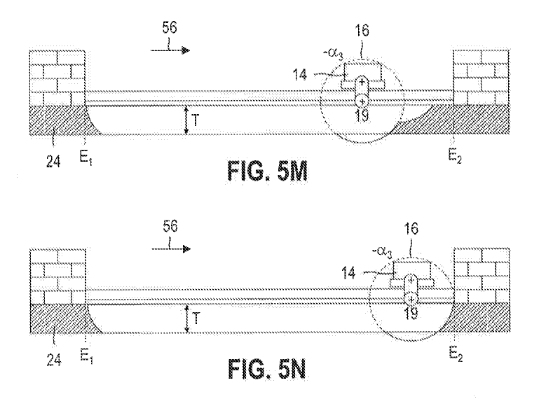

FIGS. 5A-N show the wall saw system 10 of FIG. 1 with guide rail 11 and wall saw 12 creating a separation cut of final depth T in workpiece 24 between the first end point E₁ defined as a barrier and the second end point E₂ defined as a barrier.

The processing of the separation is done with the help of the inventive method for controlling a wall saw system. The separation cut comprises a main cutting sequence of several main cuts made between the first end point E₁ and the second end point E₂, a first corner cutting sequence for the first end point E₁, and a second corner cutting sequence for the second end point E₂.

The main cutting sequence comprises a first main cut at a first main cutting angle α₁ of saw arm 17, a first diameter D₁ of the saw blade used, and a first width B₁ of the blade guard used, a second main cut at a second main cutting angle α₂ of saw arm 17, a second diameter D₂ of the saw blade used, and a second width B₂ of the blade guard used, and a third main cut at a third main cutting angle α₃ of saw arm 17, a third diameter D₃ of the saw blade used, and a third width B₂ [sic] of the blade guard used.

The first, second, and third main cuts in the embodiment are made with the saw blade 16 and associated blade guard 21. Consequently, the diameters D₁, D₂, D₃ of the main cuts match the saw blade diameter D of saw blade 16, and the widths B₁, B₂, B₃ of the main cuts match the blade guard width B of the symmetrical blade guard. Alternatively, the main cuts can be done with multiple saw blades with different saw blade diameters. When processing with multiple saw blades, the inventive method comprises a process step for changing the saw blade to another saw blade diameter.

Three method variants are suitable for processing the main cuts, which differ from each other in the processing quality of the separation cut and necessary processing time. Depending on the requirements for the separation cut, before starting the controlled processing the operator determines which method variant is used for the main cutting sequence. In the first method variant, the main cuts are done with a pulling saw arm 17. The pulling arrangement of saw arm 17 enables a stable guidance of saw blade 18 in the processing and a narrow kerf. In the second and third method steps, the saw blade 16 is arranged alternatingly pulling and pushing, with the first main cut done pulling. A separation cut in which the saw arm 17 pulls and pushes in alternation has the advantage that the nonproductive times necessary for positioning saw head 14 and pivoting saw arm 17 are reduced compared to a pulling arrangement.

In each main cut of the first method variant, there follow in succession a positioning of saw head 14, a pivoting movement of saw arm 17 at the main cutting angle, a processing in a first feed direction, a stopping of saw head 14, a pivoting of saw arm 17 at the negative main cutting angle, and a processing of the main cut in a second, counter feed direction. In each main cut of the second method variant, there follow in succession a positioning of saw head 14, a pivoting movement of saw arm 17 at the main cutting angle, a processing in a feed direction, and a stopping of saw head 14 in a position in which the upper exit point coincides with the end point. The third method variant differs from the second method variant in that the last method step of a main cut (stopping) and the first method step of the following main cut (positioning) are combined. Saw head 14 is stopped in a position calculated such that the upper exit point after the pivoting movement of saw arm 17 at the main cutting angle of the following main cut coincides with the end point.

In the embodiment, the main cuts of the main cutting sequence are done with the saw arm 17 arranged alternatingly pulling and pushing. The processing of the separation cut begins at the first end point E₁. After the start of the controlled, processing, saw head 14 is positioned in a start position X_{Start} in which the pivot axis 23 has a distance of B/2−δ sin(−α₁) to the first end point E₁. In the start position X_{Start} the saw arm 17 is rotated from the basic position at 0° in the negative rotational direction 54 at the negative first main cutting angle −α₁. After the pivoting movement at the negative first main cutting angle −α₁, the first blade guard edge 71 of blade guard 21 coincides with the first end point E₁.

The saw head 14 is moved with the saw arm 17 inclined at the negative first main cutting angle −α₁ and the rotating saw blade 16 in the positive feed direction 56 (FIG. 5A). During the feed movement the position of saw head 14 is regularly measured by the displacement sensor 33. The feed movement of saw head 14 is stopped if the pivot axis 23 has a distance to the second end point E₂ of B/2+δ sin(−α₁). In this position the second blade guard edge 72 facing the second end point E₂ coincides with the second end point E₂ and the first main cut is ended. For the second main cut, the saw head 14 is positioned in feed direction 28 such that the pivot axis 23 has a distance to the second end point E₂ of B+δ sin(−α₂). In this position saw arm 17 is rotated from the negative first main cutting angle −α₁ at the negative second main cutting angle −α₂. In the positioning the distance is set such that the second blade guard edge 72 facing the second end point E₂ after the pivoting movement of saw arm 17 at the negative second main cutting angle −α₂ coincides with the second end point E₂ (FIG. 5B).

After the pivoting movement at the negative second main cutting angle −α₂ the saw head 14 is moved in the negative feed direction 57 to the first end point E₁, wherein the position of saw head 14 is regularly measured during the feed movement by displacement sensor 33. The feed movement of saw head 14 is stopped, if the pivot axis 23 has a distance of B/2−δ sin(−α₂) to the first end point E₁. In this position the first blade guard edge 71 borders the first end point E₁ and the second main cut is ended (FIG. 5C). After the second main exit saw head 14 is positioned in the feed direction 28 such that the pivot axis 23 has a distance to the first end point E₁ of √[h₃ (D₃−h₃)]−δ sin(−α₃), where h₃=h(−α₃, D₃)=D₃/2−Δ−δ cos(−α₃) is the penetration depth of the saw blade 16 used into workpiece 24 at the negative third main cutting angle −α₃ with the third diameter D₃, which corresponds to the saw blade diameter D (FIG. 5D). In this position, saw arm 17 is pivoted out of the negative second main cutting angle −α₂ at the negative third main cutting angle −α₃ (FIG. 5E).

The third main cut is the final main cut of the main cutting sequence and, before the processing of the final main cut, the corner processing of the first end point E₁ is done. For the corner processing of the first end point E₁, the blade guard 21 is removed in order to remove as much material as possible in the corner processing. The wall saw 12 is moved by control unit 29 into a park position and saw arm 17 is rotated from the negative third main cutting angle −α₃ to the basic position at 0° (FIG. 5F). Blade guard 21 is dismounted from wall saw 12 in the park position (FIG. 5G).

Before the start of the controlled, processing of the separation cut, the first corner cutting sequence for the first end point E₁ is determined. The first corner cutting sequence in the embodiment comprises a first corner cut at a first corner cutting angle −φ_{1.1} of saw arm 17 and the first diameter D_{1.1} of the saw blade used, as well as a second corner cut with a second corner cutting angle −φ_{1.2} of saw arm 17 and a second diameter D_{1.2} of the saw blade used, wherein the second corner cutting angle −φ_{1.2} corresponds to the negative third main cutting angle −α₃. At the corner angle, the first index designates whether the corner processing occurs at the first or second end point E₁, E₂, where the index “1” stands for the first end point E₁ and the index “2” for the second end point E₂. The second index designates the cut and varies from 1 to n, n≧2. The corner processing of the first end point E₁ is done with saw blade 16 and the diameters D_{1.1} and D_{1.2} coincide with the saw blade diameter D.

Before the start of the controlled processing, a first initial position in the first end position for the corner processing of the first end point E₁ is determined. The first initial position is calculated such that the pivoting movement at ail corner putting angles −φ_{1.1}, φ_{1.2} of the first corner cutting sequence occurs before the first end point E₁ and the first end point E₁ is not overcut. In the first end position E₁ the pivot axis 23 has a local coordinate of X(E₁)+D₃/2−δ sin(±α₃) for |−α₃|≦α_{crit} and X(E₁)+D₃/2−δ sin(±α_{crit}) for α_{crit}<|−α₃|. The critical angle in the first corner processing is −90° and the negative third main cutting angle −α₃ is less than −90°, so that the first end position is calculated with the critical angle of −90°. The pivot axis 23 in the first end position has a local coordinate of X(E₁)+D₃/2−δ sin(−90°)=X(E₁)+D₃/2+δ.

The wall saw 12 is positioned from the park position into the first initial position, and in the first initial position is rotated at the first corner cutting angle −φ_{1.1} (FIG. 5H). Saw head 14 is moved with saw arm 17 inclined at the first corner cutting angle −φ_{1.1} in the negative feed direction 57 until the pivot axis 28 has reached the first end position (FIG. 5I). Saw head 14 is then put back into the first initial position (FIG. 5J), saw arm 17 is rotated at the second corner cutting angle −φ_{1.2} (FIG. 5K), and saw head 14 is moved with saw arm 17 inclined at −φ_{1.2} in the negative feed direction 57 until pivot axis 28 has reached the first end position (FIG. 5L).

After the corner cutting processing of the first end point E₁, the third main cut is done with saw arm 17 inclined at the negative third main cutting angle −α₃ in the positive feed direction 56 (FIG. 5M).

Given a powerful drive motor for the saw blade 16, the third main cut can be done without blade guard until the second saw blade edge 62 of saw blade 16 borders the second end point E₂. The feed movement of saw head 14 is stopped if the pivot axis 23 has a distance of D/2+δ sin(−α₃) to the second end point E₂ (FIG. 5N).

With weaker drive motors it can be advantageous to likewise perform the corner processing of the second end point in multiple corner cuts. Before the start of the controlled processing of the corner cut, the second corner cutting sequence is determined for the second end point E₂. The second corner cutting sequence comprises a first corner cut at a first corner cutting angle φ_{2.1} of saw arm 17 and a first diameter D_{2.1} of the saw blade used and the second corner cut with a second corner cutting angle φ_{2.2} and a second diameter D_{2.2} of the saw blade used, wherein the second corner cutting angle φ_{2.2} corresponds to the positive third main cutting angle α₃. The corner processing of the second end point E₂ is done with saw blade 16 and the diameters D_{2.1} and D_{2.2} match the saw blade diameter D.

Before the start of the controlled processing, a second initial position and a second end position are determined. The second initial position is calculated such that the pivoting movement occurs at all corner cutting angles φ_{2.1}, φ_{2.2} of the second corner cutting sequence before the second end point E₂ and the second end point E₂ is not overcut. Saw head 14, after the end of the third main cut, is moved to the second initial position and saw arm 17 in the second initial position is rotated at the first corner cutting angle φ_{2.1}. With the saw arm 17 inclined at the first corner cutting angle φ_{2.1}, saw head 14 is moved in the positive feed direction 56 until the pivot axis 23 has reached the second end position. After the removal in the first corner cut saw head 14 is returned to the second initial position, saw arm 17 in the second initial position is rotated at the second corner cutting angle φ_{2.2} and saw head 14 with the inclined saw arm 17 is moved in the positive feed direction 56 into the second end position. Saw head 14, after the end of the second corner cutting sequence, is moved into a park position and saw arm 17 in the park position is rotated out of the second corner cutting angle φ_{2.2} into the basic position at 0°.

In the embodiment of FIG. 5A-N, the pivoting movements were done from the negative first main cutting angle −α₁ to the negative second main cutting angle −α₂ and from the negative second main cutting angle −α₂ to the negative third main cutting angle −α₃ in one step. Alternatively, the pivoting movement to the negative second main cutting angle −α₂ or the negative third main cutting angle −α₃ can be done in multiple steps with intermediate angles. The decision on how many steps are required, among other things, depends on the specifications of saw blade 16, the properties of workpiece 24, and the power and torque of drive motor 18 for the saw blade. The intermediate angles can be determined by the operator or the control unit 29 of wall saw 12 can determine the intermediate angles dependent on various boundary conditions. For the inventive method, the main cutting angles of the main cuts and possible intermediate angles are an input amount used for controlling the wall saw 12.

The first corner cutting sequence for the first end point E₁ and the second corner cutting sequence for the second end point E₂ are two corner cuts. Alternatively, the corner cutting sequences can have more than two corner cuts.

1.-16. (canceled)

17. A method for controlling a wall saw system, wherein the wall saw system comprises a guide rail and a wall saw with a saw head, a motor-driven drive unit that moves the saw head parallel to a feed direction along the guide rail, a saw blade fastened on a saw arm of the saw head wherein the saw arm is pivotable about a pivot axis and around an axis of rotation, and a detachable blade guard surrounding the saw blade;
and comprising the steps of:
creating a separation cut of a final depth (T) in a workpiece of workpiece thickness (d) between a first end point (E₁) and a second end point (E₂), wherein at least one of the first and second end points is defined as a barrier, by the wall saw system;
wherein, before a start of a processing controlled by a control unit of the wall saw at least a saw blade diameter of the saw blade, positions of the first and second end points in the feed direction, the final depth of the separation cut, and a main cutting sequence of m main cuts, wherein m≧2 between the first and second end points, are determined;
wherein the main cutting sequence comprises a penultimate main cut with a penultimate main cutting angle (αₘ₋₁) of the saw arm and a penultimate diameter (Dₘ₋₁) of the saw blade, and a final main cut with a final main cutting angle (αₘ) of the saw arm and a final diameter (Dₘ) of the saw blade;
wherein, during the processing controlled by the control unit, the penultimate main cut is done with the saw arm inclined at the penultimate main cutting angle (±αₘ₋₁), and the final main cut is done with the saw arm inclined at the final main cutting angle (±αₘ);
and wherein, before the start of the processing controlled by the control unit, in addition to the main cutting sequence, a corner cutting sequence with corner cuts is determined, wherein the corner cutting sequence comprises at least a first corner cut at a first corner cutting angle (±φ_{1.1}, ±φ_{2.1}) of the saw arm and a first diameter (D_{1.1}, D_{2.1}) of the saw blade, and a second corner cut at a second corner cutting angle (±φ_{1.2}±φ_{2.2}) of the saw arm and a second diameter (D_{1.2}, D_{2.2}) of the saw blade.

18. The method according to claim 17, wherein the corner cutting sequence comprises a number of n corner cuts wherein n≧2 at j^{th} corner cutting angles (±φ₁ⱼ, ±φ_{2,j}) of the saw arm and j^{th} diameters (D₁ⱼ, D₂ⱼ) of the saw blade wherein j=1 to n.

19. The method according to claim 18, wherein before the start of the processing controlled by the control unit, in addition a saw arm length (δ) of the saw arm, defined as a distance between the pivot axis and the axis of rotation, and a distance (Δ) between the pivot axis and an upper side of the workpiece is determined.

20. The method according to claim 19, wherein the first end point (E₁) is defined as the barrier and wherein for the corner cutting sequence a first end position is calculated by the control unit, wherein the pivot axis in the first end position has a position coordinate X(E₁)+Dₘ/2−δ sin(±αₘ) for |±αₘ|≦α_{crit} and X(E₁)+Dₘ/2−δ sin(±α_{crit}) for α_{crit}<|±αₘ|.

21. The method according to claim 20, wherein in the j^{th} corner cut of the corner cutting sequence, j=1 to n the saw head is positioned in a first initial position, the saw arm is pivoted into the j^{th} corner cutting angle (±φ_{1,j}) and the saw head with the saw arm inclined at the j^{th} corner cutting angle (±φ_{1,j}) is moved into the first end position.

22. The method according to claim 21, wherein the pivot axis in the first initial position has a position coordinate X(E₁)+D_{1,n}/2−δ sin(±φ_{1,n}) for |±φ_{1,n}|≦α_{crit} and X(E₁)+D_{1,n}/2−δ sin(±α_{crit}) for α_{crit}<|±φ_{1,n}|.

23. The method according to claim 17, wherein the penultimate main cut is done with the blade guard and, before the start of the processing, in addition a mounting distance Δₘₒᵤₙₜ and a penultimate width (Bₘ₋₁) is determined for the blade guard used with the penultimate main cut, wherein the penultimate width (Bₘ₋₁) is made up of a first distance (B_{1,m-1}) of the axis of rotation to a first blade guard edge and a second distance (B_{2,m-1}) of the axis of rotation to a second blade guard edge.

24. The method according to claim 23, wherein the processing is interrupted by the control unit and the wall saw is moved by the control unit into a first park position.

25. The method according to claim 24, wherein the pivot access in the first park position has a position coordinate of X(E₁)+maximum value of [B_{1,m-1}+Δₘₒᵤₙₜ, B_{1,m-1}−δ sin(±αₘ)] for |±αₘ|≦90° or X(E₁)+maximum value of [B_{1,m-1}+Δₘₒᵤₙₜ, B_{1,m-1}−δ sin(±α_{crit})] for 90°<|±αₘ|.

26. The method according to claim 24, wherein the wall saw, after a resumption of the processing, is positioned in a first resumption position that corresponds to the first park position.

27. The method according to claim 19, wherein the second end point (E₂) is defined as the barrier and wherein for the corner cutting sequence a second end position is calculated by the control unit, wherein the pivot axis in the second end position has a position coordinate X(E₂)−Dₘ/2−δ sin(±αₘ) for |±αₘ|≦α_{crit} and X(E₂)−Dₘ/2−δ sin(±α_{crit}) for α_{crit}<|±αₘ|.

28. The method according to claim 27, wherein in the j^{th} corner cut of the corner cutting sequence, j=1 to n the saw head is positioned in a second initial position, the saw arm is pivoted into the j^{th} corner cutting angle (φ_{2,j}), and the saw head with the saw arm inclined in the j^{th} corner cutting angle (φ_{2,j}) is moved into the second end position.

29. The method according to claim 28, wherein the pivot axis in the second initial position has a position coordinate of X(E₂)−D_{2,n}/2−δ sin(±φ_{2,n}) for |±φ_{2,n}|≦α_{crit} and X(E₂)−D_{2,n}/2−δ sin(±α_{crit}) for α_{crit}<|±φ_{2,n}|.

30. The method according to claim 27, wherein the final main cut is done with the blade guard and, before the start of the processing, in addition a mounting distance Δₘₒᵤₙₜ and a final width (Bₘ) is determined for the blade guard used with the final main cut, wherein the final width (Bₘ) is made up of a first distance (B_{1,m}) of the axis of rotation to a first blade guard edge and a second distance (B_{2,m}) of the axis of rotation to a second blade guard edge.

31. The method according to claim 30, wherein the processing is interrupted by the control unit and the wall saw and saw head are moved by the control unit into a second park position.

32. The method according to claim 31, wherein the pivot axis in the second park position has a position coordinate of X(E₂)−maximum value of [B_{2,m}+Δₘₒᵤₙₜ, B_{2,m}+δ (±αₘ)] for |±αₘ|≦90° or X(E₂)−maximum value of [B_{2,m}+Δₘₒᵤₙₜ, B_{2,m}+δ sin(±90°)] for 90°<|±αₘ|.

33. A method for controlling a wall saw system, comprising the steps of:
defining a main cutting sequence for making a main cut in a workpiece;
defining a corner cutting sequence with corner cuts, wherein the corner cutting
sequence comprises a first corner cut with a first corner cutting angle of a saw arm of a saw and a second corner cut at a second corner cutting angle of the saw arm of the saw; and
cutting the workpiece by the saw with the main cutting sequence and the corner cutting sequence.
